(19) United States
(12) Patent Application Publication
(10) Pub. No.: US 2007/0094708 A1
(43) Pub. Date: Apr. 26, 2007

(54) System and method for automatically activating an electronic device

(75) Inventor: John P. Hess, Richmond, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: CAPITAL ONE FINANCIAL CORPORATION

(21) Appl. No.: 11/259,973

(22) Filed: Oct. 26, 2005

(51) Int. Cl. H04L 9/32

(52) U.S. Cl. 726/2

(57) ABSTRACT

An electronic device may be remotely activated by an activation utility, such as a remote start-up utility. The remote utility may be initiated in response to activation of a security system. The security system may generate an electronic signal which initiates the remote utility. The remote utility sends activation instructions to the device. The device may perform the activation tasks while a user is moving from the security system location to the device location.

### TECHNICAL FIELD

The present invention relates generally to computer systems and, more particularly, to systems and methods for automatically starting a computer.

### BACKGROUND

Computer systems are known. It is common for a company to use a network of computers for performing a variety of applications related to the company's business. The applications may range from specialized computer programs directly related to the operations of a particular business to programs designed to assist personnel in managing a variety of ancillary business tasks, such as accounting, human resources management, staffing, time entry, etc. Computers within an enterprise may be linked, or networked, together according to a variety of configurations.

Applications are commercially available for remotely starting a computer. For example, a utility known as Wake-on-LAN (WoL) can remotely start a computer system under certain circumstances. A WoL utility is available, for example, from SolarWinds™. The WoL utility has the ability to “power on” a PC remotely by the generation of a “magic packet” which is distributed to PCs on a network. When a remote network adapter hears a “magic packet” created for its unique MAC address, the network adapter alerts the computer to power on. If WoL has been enabled in the computer's BIOS settings, the system will power on as if the power button had been pressed.

Building security systems are generally known. Such systems are used to ensure that only authorized personnel enter a building and/or particular areas within a building. Security systems can operate based on a number of different types of technologies. An example security system uses a card reader to read information stored on security cards carried by employees. Another example system uses a keypad to receive an entry code. Other systems use biometrics such as retina scanning or fingerprint identification.

### SUMMARY OF THE INVENTION

Certain embodiments of the present invention are generally directed to systems and methods that integrate building security systems with remote computer start-up applications. For example, activation of a security system may, in turn, initiate a remote computer start-up utility. Thus, when an employee enters a building, the employee's computer may be started automatically and remotely while the employee is moving from the security point to the computer location.

According to one embodiment, a system is provided for remotely activating an electronic device. The system includes an authorization subsystem for providing authorization to a user based on user input. The authorization subsystem is operable to generate an authorization signal corresponding to the authorization. The system also includes a remote activation utility in electronic communication with the authorization subsystem. The remote activation utility is operable to receive the authorization signal, and is further operable to generate an activation instruction upon receiving the authorization signal. The system also includes at least one electronic device in electronic communication with the remote activation utility. The electronic device is operable to receive the activation instruction and perform at least one electronic task based on the activation instruction.

Another embodiment includes a method for remotely activating an electronic device. One step includes receiving an electronic authorization signal from an authorization system. Another step includes initiating a remote activation utility in response to the received electronic signal. Another step includes using the remote activation utility to generate activation information. The activation information includes at least one activation instruction for the electronic device.

Various embodiments of the present invention may benefit from numerous advantages. It should be noted that one or more embodiments may benefit from some, none, or all of the advantages discussed below.

One advantage is that while a person is moving from a security point to a location where the user's computer is positioned, start-up functions for the user's computer may take place. This avoids the need to delay the start-up functions until the user is located at the computer. Thus, the time a user normally spends powering up his or her computer, and performing related start-up tasks, is saved. This results in a savings of work and costs.

Another advantage is the convenience associated with remotely and automatically activating an electronic device. A user does not have to manually perform these functions by directly interfacing with the device.

Another advantage is that devices may be automatically and remotely deactivated upon the user leaving the premises where the device is located. This increases security with respect to computer systems, for example, by avoiding a situation where a computer is left on when a person leaves the work space.

Another advantage is that a remote activation utility, such as a remote computer start-up utility, can be automatically initiated in response to an electronic signal, rather than in response to an affirmative act by a person to start the utility.

### BRIEF DESCRIPTION OF THE DRAWINGS

For a more complete understanding of the present invention and for further features and advantages, reference is now made to the following description, taken in conjunction with the accompanying drawings, in which:

FIG. 1 illustrates an example system for remotely activating a device in accordance with an embodiment of the invention; and

FIG. 2 illustrates an example method for remotely activating a device in accordance with an embodiment of the invention.

### DETAILED DESCRIPTION

Certain embodiments of the present invention are generally directed to systems and methods for activating a computers system. In at least one embodiment, the computers system is activated remotely using a combination of a remote start-up utility and a security system. Activation of the security system, or the occurrence of a certain signal within the security system, initiates the remote start-up utility. The remote start-up utility, in turn, powers up the computer system and designated applications. The computer system that is started may be linked to the particular signal generated or received by the security system, such that a particular security signal results in activation of a particular computer system.

In one embodiment, an employee uses a security system to gain entry into a building. For example, the employee may swipe an identification card through a card reader at the point of entry. The card reader reads information from the identification card. Some of the information corresponds to an identification of a particular computer system within the building. For example, the corresponding computer system may be a system within the employee's office and regularly used by the employee. When the card reader reads an appropriate code, the employee is allowed entry into the building. The security system also sends an authorization signal to a remote computer start-up utility, which may be maintained, for example, on a server linked to multiple computers including the employee's computer. The authorization signal initiates the remote start-up utility and may also include the appropriate data necessary for the utility to identify the employee's computer as the particular computer to power up. The remote start-up utility sends the data to the employee's computer, automatically powers up the computer, and starts any pre-designated applications on the computer. All of this may occur as the employee is traveling from the point of entry to his or her office. Thus, the employee does not have to spend time powering up the computer and various applications after reaching the office.

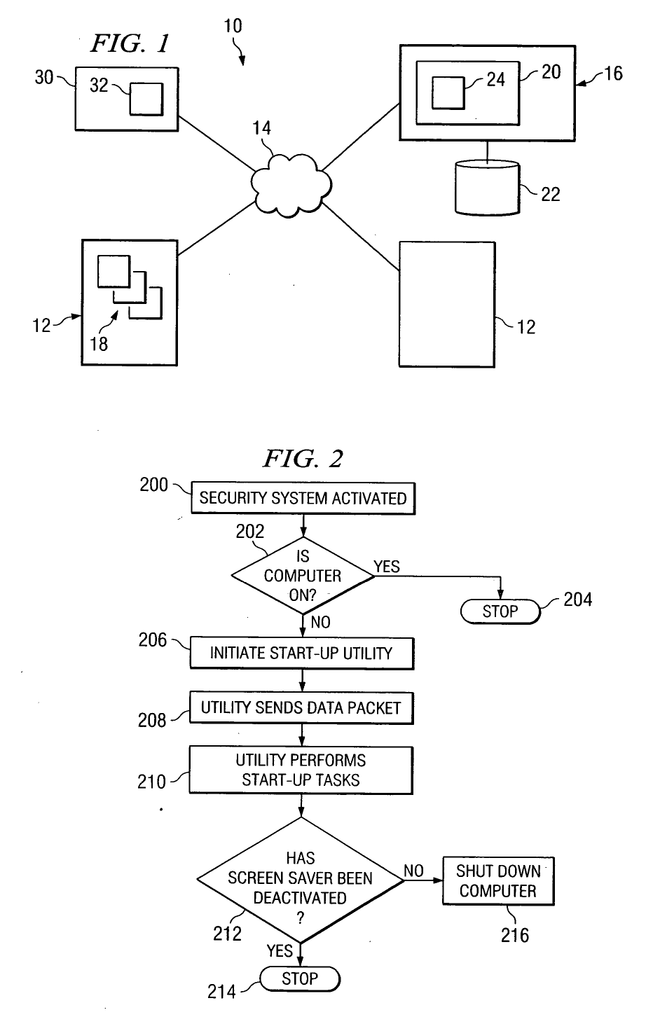

Example embodiments of the present invention and their advantages are best understood by referring to FIGS. 1 and 2 of the drawings, in which like numerals refer to like parts. As shown in FIG. 1, for example, a computer start-up system 10 is shown. System 10 includes a plurality of computers 12. Although the term “computers” is used, it is intended that this description encompasses any device having a processor. Such devices may include, for example, personal computers, desktops, laptops, servers, routers, computer networks, mini-computers, personal data assistants, mobile telephones, wireless computers, wireline computers, databases, handheld devices, and electronic devices or systems incorporating one or more processors. Certain embodiments also include electronic devices that do not incorporate a processor, but that can be electronically activated.

Computers 12 are linked through a communications network 14. Network 14 is any network capable of allowing the passage of data from one point to another, such as from one computer 12 to another computer 12. As such, communications network 14 may include, for example, a wired local area network (LAN) based on any of a variety of protocols, such as Ethernet, token ring, or fiber distributed data interface (FDDI) protocols, and including any of a variety of topologies, such as bus, ring, star, or tree topologies, for example. Communications network 14 may include one or more local area networks (LANs), metropolitan area networks (MANs), wide area networks (WANs), portions of the Internet, or any other appropriate wireline, optical, wireless, or other links.

System 10 also includes a server 16, which is linked to the other components of system 10 through communications network 14. Although the term “server” is used, it is intended that any appropriate device is encompassed within this description. Server 16 may be any device that is capable of causing the transmission of an electronic signal to at least one computer 12. Preferably, server 16 has one or more inputs and outputs (not expressly shown) operable to receive and transmit data. Server 16 includes one or more processors 20 operable to process electronic data. Server 16 may store and execute a remote start-up utility 24. Utility 24 may be located within server 16 as shown. However, utility 24 may be partially or completely stored at one or more other points within, or remotely from, system 10.

Utility 24 is preferably operable to perform at least one task related to starting up at least one of computers 12. In certain embodiments, utility 24 is operable to send data to one or more computers 12 on the network. In at least one embodiment, utility 24 sends data to all of the computers. According to one aspect, the data may be sent to a network interface (not expressly shown) which is either a component of, or coupled to, the computer. When activated, utility 24 may send data (which may be, for example, in the form of a packet) to computers 12. The data may include identifying information that corresponds to one or more of the computers. The computers may receive the data and process the data to determine whether (e.g., based on the identifying information) the data is intended for the respective computer. If the data is intended for the respective computer, that computer may be instructed to perform one or more start-up functions, such as powering on.

In the illustrated embodiment, a computer 12 may have a plurality of applications 18 either stored on, or available for execution on, the computer. Applications 18 may include any suitable applications including, for example, login, screen-saver, word processing, data entry, record keeping, configuration, startup, and other applications. In at least one embodiment, the WoL tool includes data to power up the computer, automatically sign on (or perform a login operation), retrieve a pre-determined applications list, start the applications in the list (or perform a similar initialization or start-up routine), sign on to the applications, and activate a password-protected screen saver application.

In at least one example embodiment, utility 24 is a remote start-up utility operable to start a computer 12. For instance, a remote start-up utility is available as a Wake-on-LAN (WoL) tool from SolarWinds™. This particular start-up utility may be used in conjunction with a personal computer that is configured to accept a WoL remote command. Preferably, the computer's Internet Protocol (IP) address and Media Access Control (MAC) address of the computer are known and used for matching to the data sent from the WoL utility. When the computer shuts down, its Network Interface Card (NIC) is still receiving power. The NIC keeps listening for a “magic packet” to arrive. The WoL tool has the ability to send a “magic packet” packet and instruct the remote computer to power-on. The “magic packet” is a specifically formatted data packet sent over the network. It may be sent to all NICs. Identifying data (e.g., the IP and MAC address information) in the packet allows each NIC to determine whether the magic packet is intended for it. All non-intended cards reject and/or dispose of the packet. Although the SolarWinds™ WoL tool has been described in connection with this embodiment, it should be understood that this description encompasses any suitable remote application including any remote application that is used for, or related to, starting up a computer or any of the computer's applications or other functionality. Also within the scope of certain embodiments are utilities or similar applications that are capable of starting any electronic, or electronically-activated, device or system.

System 10 also includes at least one storage device 22. Storage device 22 is coupled to processor 20 and may be any suitable device or component for storing data. For, example, storage device 22 may include one or more random access memories (RAMs), read-only memories (ROMs), dynamic random access memories (DRAMs), fast cycle RAMs (FCRAMs), static RAM (SRAMs), field-programmable gate arrays (FPGAs), erasable programmable read-only memories (EPROMs), electrically erasable programmable read-only memories (EEPROMs), microcontrollers, or microprocessors. In certain embodiments, storage device 22 maintains identifying information for the plurality of computers 12. In this configuration, the processor may query storage device 22 to obtain the identifying information (such as the IP and MAC address) for a particular computer associated with a particular user. The processor may then send the start-up instructions to the one particular computer instead of sending information to all computers in the network. In an alternative scenario, processor 20 may query a plurality of records in storage device 22, wherein each of the records is associated with one of the plurality of computers 12 in the network. When the processor (executing the WoL utility) identifies the appropriate record, the processor retrieves the identifying information (e.g., IP and MAC address) and delivers the start-up instructions to the appropriate computer 12. It should be understood that a variety of configurations are possible for identifying the computer(s) to which the start-up instructions are delivered. It should be understood that the term “start-up” refers to activating any task, application, etc., that must be initiated or performed electronically.

System 10 also includes a security system 30. Security system 30 may be any suitable security system, including without limitation, a system that, accepts input and determines, based on the input, whether an authorization or verification signal should be generated. In the example embodiment, security system 30 is a system for regulating access to a building entry point. For instance, security system 30 may be used to prevent or allow people to enter a door to a building. When a user is authorized, based on the input received by system 30, system 30 may generate an authorization signal. The authorization signal may be sent to any number of locations based on the configuration of the system. For example, the authorization signal may be sent to a database or a processor for generating a record of the authorization. The record may include, for example, a time stamp for later determining the time the signal was generated and/or the time the user accessed system 30 or entered the building. In another scenario, the authorization signal may be sent to activate a device, such as the door to the building. An electronic signal may be sent to an electronic lock on the door, thereby causing the door to be in an unlocked state and allow the user to enter. The authorization signal may be sent to multiple locations and may be processed in any suitable way to activate a device (e.g., electronic lock) or generate additional signals or electronic data.

Security system 30 may include a user interface 32. User interface 32 may be any device or system for receiving input from, or associated with, a user. Interface 32 may be, for instance, a card reader. The card reader may have a slot or channel for swiping a security card. A user such as an employee may swipe a security card in interface 32. The card reader reads information stored in or on the security card, such as in a magnetic strip or in an RFID chip. The card reader may then send the data to a processor (not expressly shown) for comparison to stored information to determine whether to authorize the user to enter the building. In other examples, interface 32 may be a computer used by an operator, such as a security guard. The operator may receive information from the person seeking entry and may enter the information in the computer to determine whether the person should be allowed to enter. User interface 32 may include additional types of interfaces including keypads for entry of alpha-numeric codes, biometric readers, voice recognition units, etc. Any interface is suitable as long as it is capable of determining, or being used to determine, whether a person should be allowed entry or some other type of authorization. Security system 30 and/or interface 32 may be located at any suitable location including a building entry, garage entry, internal door, desk or cabinet lock, time keeping device, or any device or appliance that can read information input by a user.

In the example embodiment shown, a user, such as an employee, may access the user interface device 32 of security system 30 to gain entry into a building. The security system 30 determines, based on the input information and stored information whether the user should be permitted to enter. If a positive determination is made, the security system sends a signal to server 16 indicating the user has been allowed entry. Server 16 executes the WoL utility to send the appropriate data to the user's computer, which may be remotely located (e.g., within the user's office in the building). While the user is traveling from the building entry point to his or her office, the WoL utility is performing the various start-up tasks previously discussed. Thus, the user does not have to spend the additional time necessary to perform these tasks once the user reaches his or her office.

FIG. 2 illustrates an example method of remotely activating a computer (or other device). The method may be performed using the system illustrated in FIG. 1. However, the invention is not so limited, and the method may be performed using any suitable system which is capable of performing the steps of the method. It should also be understood that FIG. 2 only illustrates one example method. Other methods are covered by this description. Moreover, while the illustrated method includes certain steps in a certain order, it is within the scope of certain embodiments that the order of the steps may be changed. Also, certain steps may be eliminated, altered, or repeated. Further, additional steps may be included.

The method begins with step 200 in which a user accesses an authorization system. The authorization system may be any system which accepts input from a user to determine whether an authorization should be indicated and/or whether some action should be taken. The authorization system may comprise, for example, a security system such as a building security system. For example, the user may access a security system interface, such as a card reader, biometric reader, key pad, etc. Alternatively, a second user may obtain identification information from the first user and enter the information into a computer to determine authorization.

At step 202, a query is made as to whether the first user's computer is on. If the computer is on, then the method ends at step 204. The query may be made by a utility application, such as a network administration application. For example, the user identification may be associated with identifying information for the user's computer, such as an IP address. Using the IP address, the network administration application can assess whether the particular computer is on.

At step 206, if it is determined that the user's computer is not on, a start-up utility is activated. Preferably, the start-up utility is activated by the receipt of a signal, or electronic trigger, from the security system. The start-up utility may be any of the utilities discussed herein. For example, the utility may be a WoL utility.

At step 208, the start-up utility sends a data packet to all of the computers on the network in order to determine which computer is associated with identifying information contained in the data packet. Alternatively, if it has been previously determined which computer is associated with the user, then the start-up utility can skip this step and move to the start-up procedures of step 210.

At step 210, the start-up utility performs a plurality of start-up tasks. For example, the utility may cause the computer to power up. The start-up utility may sign on to the computer, retrieve a predetermined list of applications to be executed on the computer, start up the listed applications, and sign on to the various applications. Additionally, the utility may activated a password-protected screen saver. The start-up utility may initiate, perform, or cause to be performed, any task that may be performed electronically.

At step 212, at a predetermined period of time after the computer is started, the utility, or other appropriate application, determines whether a correct password has been entered to unlock the screen saver. If, the screen saver has been deactivated, then, at step 214, the method stops. If the screen saver has not been deactivated within the predetermined time period, then the computer is shut down at step 216.

Although an embodiment of the invention and its advantages are described in detail, a person skilled in the art could make various alterations, additions, and omissions without departing from the spirit and scope of the present invention as defined by the appended claims.

For example, in certain embodiments, the activation of tasks for the electronic device (e.g., a computer) may be triggered by somebody exiting (rather than entering) through a security point. One example of this configuration involves an employee leaving his or her office with the computer still on. This might occur unintentionally, or the computer might be left on with the intention that the employee will return to the office. Regardless, the employee might not return and power off his or her computer. Instead, the employee may decide to leave the building. For example, an employee might leave his or her office to attend a late afternoon conference within the building but on a different floor. After the conference, the employee may decide that he or she would rather go straight to the building exit (to go home) rather than return to his or her office. When the employee goes through the security point (e.g., the door to the outside of the building), the same systems and methods previously described may be used to send various instructions to the computer. For example, the employee passing through a security point may cause a signal to be sent to a remote activation utility, which may in turn send activation instructions to the employee's computer. The activation instructions may include instructions to log out of various applications and perform a shut-down routine.

1. A system for remotely activating an electronic device, the system comprising:
an authorization subsystem for providing authorization to a user based on user input, and operable to generate an authorization signal corresponding to the authorization;
a remote activation utility in electronic communication with the authorization subsystem, and operable to receive the authorization signal, and further operable to generate an activation instruction upon receiving the authorization signal; and
at least one electronic device in electronic communication with the remote activation utility, the electronic device operable to receive the activation instruction and perform at least one electronic task based on the activation instruction.

2. The system of claim 1, wherein the electronic device comprises a computer.

3. The system of claim 1, wherein the authorization system is a security system.

4. The system of claim 3, wherein the security system comprises a user interface for receiving the user input.

5. The system of claim 1, wherein the user input comprises electronic information stored on a card.

6. The system of claim 1, wherein the user input comprises biometric information.

7. The system of claim 6, wherein the biometric information comprises fingerprint scan information.

8. The system of claim 6, wherein the biometric information comprises retina scan information.

9. The system of claim 1, wherein the user input comprises an alpha-numeric code.

10. The system of claim 1, wherein the security system regulates access to an area in which the electronic device is located.

11. The system of claim 1, wherein the security system regulates access to a first area, and wherein the electronic device is located.

12. The system of claim 1, wherein the activation instruction comprises a power-on instruction.

13. The system of claim 1, wherein the activation instruction comprises a power-off instruction.

14. The system of claim 1, wherein the activation instruction comprises a log-in instruction.

15. The system of claim 1, wherein the activation instruction comprises an instruction comprises an instruction to start a computer application.

16. The system of claim 1, wherein the activation instruction is included in a data packet.

17. The system of claim 16, wherein the data packet includes data received from the authorization subsystem.

18. The system of claim 1, further comprising a server, the remote activation utility being executed on the server.

19. The system of claim 1, wherein the remote activation utility is executed on the electronic device.

20. The system of claim 1, wherein the remote activation utility is a start-up utility.

21. The system of claim 1, wherein the remote activation utility is a Wake-on-LAN utility.

22. The system of claim 1, wherein the remote activation utility identifies a particular electronic device from a plurality of electronic devices, the particular electronic device being associated with the user of the authorization subsystem, and wherein the remote activation utility sends a signal only to the particular electronic device.

23. The system of claim 1, wherein the remote activation utility sends an identification signal to a plurality of electronic devices in communication with the remote activation utility, the signal being received by the plurality of electronic devices, wherein a subset of the plurality of electronic devices is identified as being associated with the user of the authorization subsystem.

24. The system of claim 1, wherein the authorization subsystem is a security system for regulating entry to an area by the user, and wherein entry into the area triggers the remote activation utility.

25. The system of claim 1, wherein the authorization subsystem is a security system for regulating egress from an area by the user, and wherein egress from the area triggers the remote activation utility.

26. The system of claim 1, wherein the authorization subsystem receives data associating the user with the electronic device.

27. A method for remotely activating an electronic device, comprising:
receiving an electronic authorization signal from an authorization system;
initiating a remote activation utility in response to the received electronic signal;
using the remote activation utility to generate activation information, the activation information comprising at least one activation instruction for the electronic device.

28. The method of claim 27, further comprising the step of reading security information associated with a user to generate the electronic authorization signal.

29. The method of claim 27, wherein the electronic authorization signal is generated by a security system in response to user input.

30. The method of claim 27, further comprising sending device identification information from the remote activation utility to at least one electronic device.

31. The method of claim 30, wherein the device identification information is sent to a plurality of electronic devices for comparison with identification information corresponding to each of the plurality of electronic devices.

32. The method of claim 30, wherein the activation information further comprises device identification information, the method further comprising the step of comparing identification information in the activation information to corresponding identification information associated with the electronic device.

33. The method of claim 27, wherein the remote activation utility is a remote computer start-up utility.

34. The method of claim 27, wherein the electronic authorization signal is generated in connection with a user entering an area in which the electronic device is located.

35. The method of claim 27, wherein the electronic authorization signal is generated in connection with a user leaving an area in which the electronic device is located.
